(19) United States
(12) Patent Application Publication
(10) Pub. No.: US 2021/0055500 A1
(43) Pub. Date: Feb. 25, 2021

(54) CAMERA MODULE, ELECTRONIC DEVICE HAVING CAMERA MODULE, AND METHOD FOR MANUFACTURING THE CAMERA MODULE

(71) Applicant: TRIPLE WIN TECHNOLOGY(SHENZHEN) CO.LTD., Shenzhen (CN)

(72) Inventors: SHUAI-PENG LI, Shenzhen (CN); JING-WEI LI, Shenzhen (CN); SHENG-JIE DING, Shenzhen (CN); SHIN-WEN CHEN, Tu-Cheng (TW)

(21) Appl. No.: 16/738,171

(22) Filed: Jan. 9, 2020

(30) Foreign Application Priority Data
Aug. 20, 2019 (CN) 201910770164.5

(51) Int. Cl. G02B 7/02

(52) U.S. Cl. CPC G02B 7/022; G02B 7/025

(57) ABSTRACT

A camera module comprising components held stably without glue includes a substrate and a lens assembly thereon. The lens assembly includes a lens holder, an optical filter, and a lens. The lens holder includes first and second holder portions, and a fixing block. The first holder portion includes a peripheral wall and a protruding flange; and the second holder portion is disposed on the first holder portion. The fixing block is on the flange away from the second holder portion, causing the fixing block and the flange to cooperatively form a clamping slot. The optical filter is disposed on the flange away from the second holder portion, an edge portion thereof being received in the clamping slot. The lens is disposed in the second holder portion. An electronic device and a method for making camera module are also provided.

### FIELD

The disclosure generally relates to a camera module, an electronic device and a method for manufacturing the camera module.

### BACKGROUND

When taking pictures, infrared light occurring naturally is taken by the sensor of the camera, which causes the pictures to be vague and reddish. Thus, an infrared filter is added to the camera to filter out infrared light. The infrared filter is fixed in the camera by glue. However, an excess of glue may overflow in the camera. Furthermore, the bonding strength of the infrared filter may be poor. Therefore, there is room for improvement in the art.

### BRIEF DESCRIPTION OF THE FIGURES

Implementations of the present disclosure will now be described, by way of example only, with reference to the attached figures.

FIG. 1 is a view of an embodiment of an electronic device.

FIG. 2 is a view of a camera module of the electronic device of FIG. 1.

FIG. 3 is an exploded view of the camera module of FIG. 2.

FIG. 4 is another exploded view, from a different view, of the camera module of FIG. 2.

FIG. 5 is a cross-sectional view taken along line V-V of FIG. 2.

FIG. 6 is a view of an embodiment of a lens holder of the camera module of FIG. 2.

FIG. 7 is a flow chart illustrating a method for manufacturing a camera module of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiment described herein can be practiced without these specific details. In other instances, methods, procedures, and components have not been described in detail so as not to obscure the related relevant feature being described. Further, the description is not to be considered as limiting the scope of the embodiments described herein. The drawings are not necessarily to scale and the proportions of certain parts may be exaggerated to better illustrate details and features of the present disclosure.

The term “comprising” when utilized, means “include, but is not limited to”; it specifically indicates open-ended inclusion or membership in the so-described combination, group, series and the like. The term “coupled” when utilized, means “either a direct electrical connection between the things that are connected, or an indirect connection through one or more passive or active intermediary devices, but is not limited thereto”.

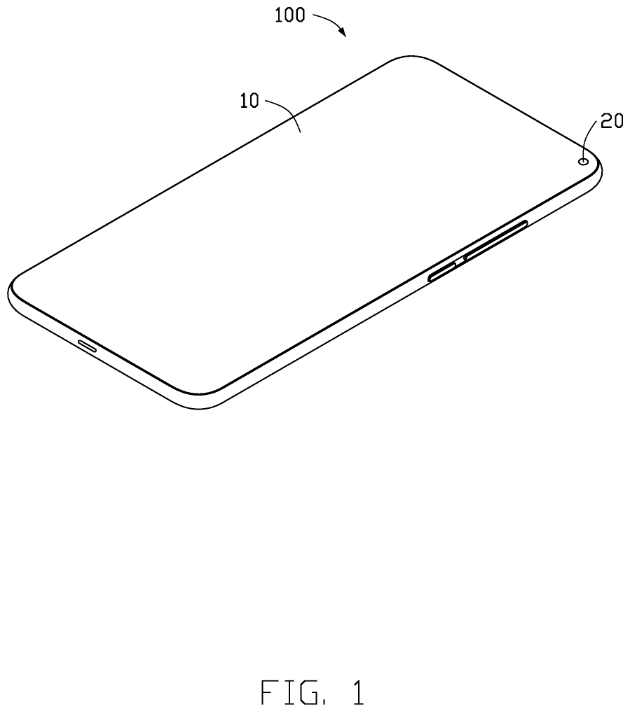

FIG. 1 illustrates an embodiment of an electronic device (electronic device 100). The electronic device 100 includes a body 10 and a camera module 20 disposed in the body 10. In at least one embodiment, the electronic device 100 is a mobile phone. In other embodiments, the electronic device 100 may be a computer, a wearable device, or a monitoring device.

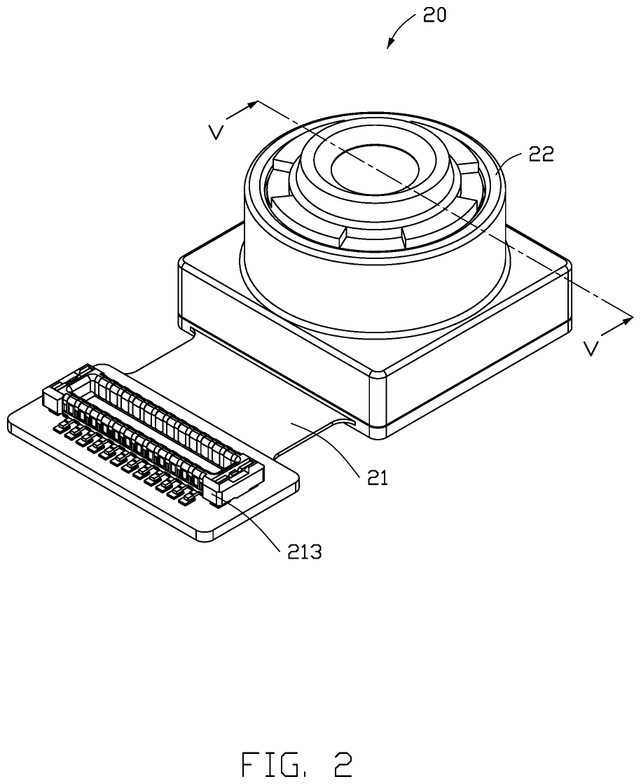

Referring to FIG. 2, the camera module 20 includes a substrate 21 and a lens assembly 22.

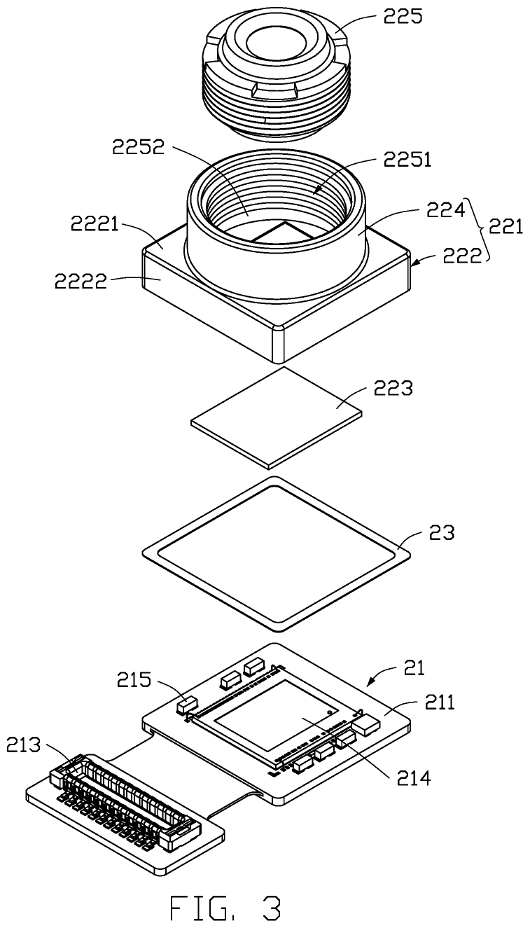

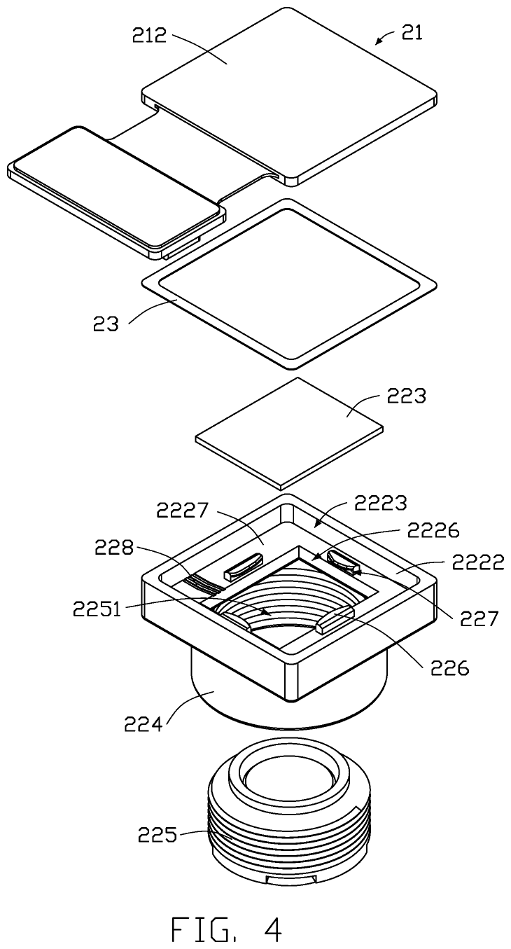

Referring to FIG. 3 and FIG. 4, the substrate 21 includes an upper surface 211 and a lower surface 212 opposite the upper surface 211. In at least one embodiment, the substrate 21 is a RF (radio frequency) printed circuit board.

In at least one embodiment, an electric connecting member 213 is disposed on the upper surface 211. The electric connecting member 213 is electrically connected to the lens assembly 22. When the camera module 20 is installed in the electronic device 100, the electric connecting member 213 is electrically connected to other components (not shown) of the electronic device 100 to implement signal transmission between the camera module 20 and the components in the electronic device 100. The electric connecting member 213 may be a connector, a connecting finger, or other element that can perform the function of electrical connection.

Further, a photosensitive chip 214 and a plurality of electronic components 215 are disposed on the upper surface 211. In at least one embodiment, the photosensitive chip 214 and the plurality of the electronic components 215 are disposed on a side of the upper surface 211 away from the electric connecting member 213. The electronic component 215 can be selected from one or more of a resistor, a capacitor, a diode, a transistor, a relay, a memory, and other passive components.

In at least one embodiment, the plurality of the electronic components 215 are disposed on a periphery of the photosensitive chip 214. The plurality of the electronic components 215 are arranged in two columns, and the photosensitive chip 214 is located between two columns of electronic components 215.

Referring to FIGS. 3, 4 and 5, the lens assembly 22 is disposed on the upper surface 211 and covers the photosensitive chip 214 and the plurality of electronic components 215.

In at least one embodiment, the camera module 20 includes an adhesive layer 23. The adhesive layer 23 is disposed between the substrate 21 and the lens assembly 22. The substrate 21 and the lens assembly 22 are connected by the adhesive layer 23.

In other embodiments, the adhesive layer 23 can be omitted. As such, the substrate 21 and the lens assembly 22 may be connected by snap-fitting, soldering, or screwing.

Referring to FIGS. 3, 4 and 5, the lens assembly 22 includes a lens holder 221, an optical filter 223, and a lens 225.

The lens holder 221 includes a first holder portion 222 and a second holder portion 224 disposed on the first holder portion 222. In at least one embodiment, the first holder portion 222 is integrally formed with the second holder portion 224. In other embodiments, the first holder portion 222 and the second holder portion 224 can also be separate components needing to be assembled.

The first holder portion 222 includes a top wall 2221 and a peripheral wall 2222. The second holder portion 224 is formed on the top wall 2221. The peripheral wall 2222 is disposed around a periphery of the top wall 2221 to form an accommodating space 2223 together with the top wall 2221. As such, when the lens assembly 22 is disposed on the upper surface 211, the photosensitive chip 214 and the plurality of electronic components 215 are received in the accommodating space 2223.

The first holder portion 222 further includes a flange 2227 protruding from an inner wall of the peripheral wall 2222. The flange 2227 includes a first surface 2224 facing the second holder portion 224 and a second surface 2225 opposite the first surface 2224. The flange 2227 defines an opening 2226. The opening 2226 extends through the top wall 2221, and is connected to the accommodating space 2223.

The optical filter 223 is disposed on the second surface 2225 and covers the opening 2226. The optical filter 223 filters undesirable or excessive light such as infrared light or visible light. In at least one embodiment, the optical filter 223 may be a blue glass or an IR glass.

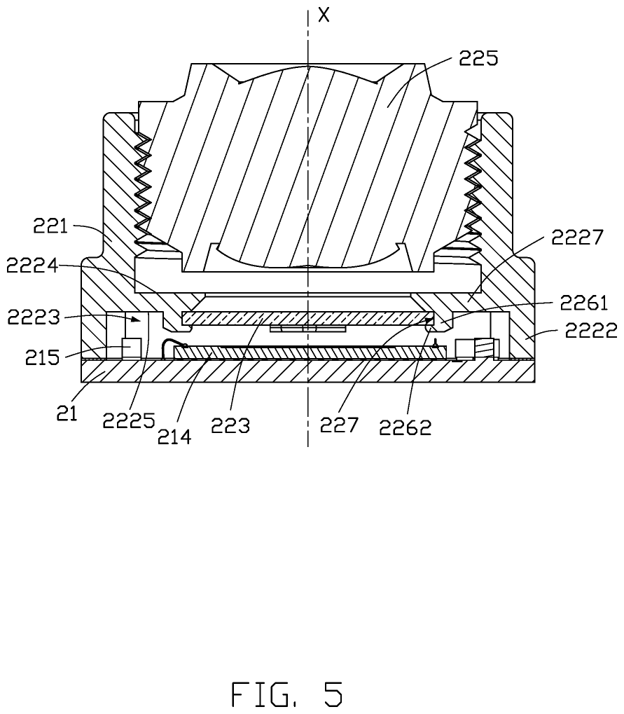

The lens holder 221 further includes a fixing block 226. The fixing block 226 is disposed on the second surface 2225 for fixing the optical filter 223 to the second surface 2225. The fixing block 226 is located at a portion of the flange 2227 surrounding the opening 2226. The fixing block 226 and the flange 2227 cooperatively form a clamping slot 227 (refer to FIG. 5). In at least one embodiment, four fixing blocks 226 are uniformly disposed around the opening 2226. In other embodiments, the number of the fixing blocks 226 can be adjusted, for example, the number of the fixing blocks 226 may be two, three, five, and the like.

Referring to FIGS. 4 and 5, the fixing block 226 includes a first fixing portion 2261 and a second fixing portion 2262. One end of the first fixing portion 2261 is connected to the second surface 2225. The first fixing portion 2261 is perpendicular to the second surface 2225. The second fixing portion 2262 is connected to the other end of the first fixing portion 2261 facing away from the second surface 2225. The second fixing portion 2262 extends toward a central axis X of the lens holder 221, so that the second fixing portion 2262, the first fixing portion 2261, and the flange 2227 cooperatively form the clamping slot 227. As such, when the optical filter 223 is disposed on the second surface 2225 and is covering the opening 2226, an edge portion of the optical filter 223 is received in the clamping slot 227, so that the optical filter 223 is fixed to the second surface 2225.

Further, the second surface 2225 defines an escape groove 228. The escape groove 228 is connected to the opening 2226. In at least one embodiment, the escape groove 228 includes a plurality of grooves 2281. The grooves 2281 are arranged parallel to each other. The groove 2281 has a strip structure. In other embodiments, the shape of the escape groove 228 can be adjusted. The shape of the escape groove 228 may be L-shaped or T-shaped.

The second holder portion 224 is used to fix the lens 225. The second holder portion 224 defines a through hole 2251. The through hole 2251 is connected to the opening 2226. The lens 225 is received in the through hole 2251 and exposed to the through hole 2251. The through hole 2251 forms a circumferential surface 2252. The circumferential surface 2252 is provided with an internal thread, and the outer surface of the lens 225 is provided with an external thread corresponding to the internal thread. As such, the lens 225 and the second holder portion 224 are connected by the engagement of the internal thread and the external thread.

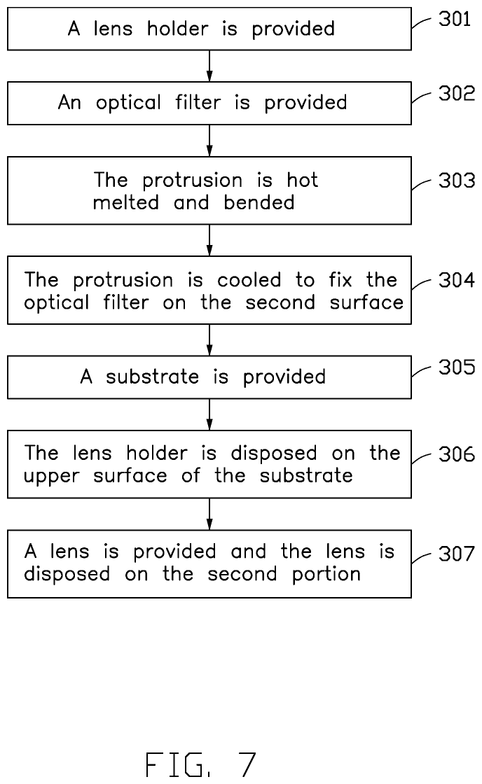

Referring FIG. 7, a method for manufacturing the camera module 20 is illustrate. The method can begin at block 301.

At block 301, a lens holder 221 is provided. In at least one embodiment, the lens holder 221 may be produced by injection molding.

Referring to FIGS. 3, 4 and 5, the lens holder 221 includes a first holder portion 222 and a second holder portion 224.

The first holder portion 222 includes a top wall 2221 and a peripheral wall 2222. The second holder portion 224 is formed on the top wall 2221. The peripheral wall 2222 is disposed on a periphery of the top wall 2221 to form an accommodating space 2223 together with the top wall 2221. The first holder portion 222 further includes a flange 2227 protruding from an inner wall of the peripheral wall 2222. The flange 2227 includes a first surface 2224 facing the second holder portion 224 and a second surface 2225 opposite the first surface 2224. The flange 2227 defines an opening 2226. The opening 2226 extends through the top wall 2221 and is connected to the accommodating space 2223.

The lens holder 221 further includes a protrusion 229. The protrusion 229 is integrally formed with the first holder portion 222 and the second holder portion 224. The protrusion 229 is located at a portion of the flange 2227 surrounding periphery of the opening 2226. In at least one embodiment, the lens holder 221 includes four protrusions 229. Four protrusions 229 are uniformly disposed around the opening 2226. In other embodiments, the number of the protrusions 229 can be adjusted, for example, the number of the protrusions 229 may be two, three, five, and the like.

Further, the second surface 2225 defines an escape groove 228. The escape groove 228 is connected to the opening 2226. In at least one embodiment, the escape groove 228 includes a plurality of grooves 2281. The grooves 2281 are arranged parallel to each other. The groove 2281 has strip structure. In other embodiments, the shape of the escape groove 228 can be adjusted. The shape of the escape groove 228 may be L-shaped or T-shaped.

The second holder portion 224 defines a through hole 2251. The through hole 2251 is connected to the opening 2226. The through hole 2251 forms a circumferential surface 2252 at the second holder portion 224. The circumferential surface 2252 is provided with an internal thread.

At block 302, an optical filter 223 is provided. In at least one embodiment, the optical filter 223 may be a blue glass or IR glass.

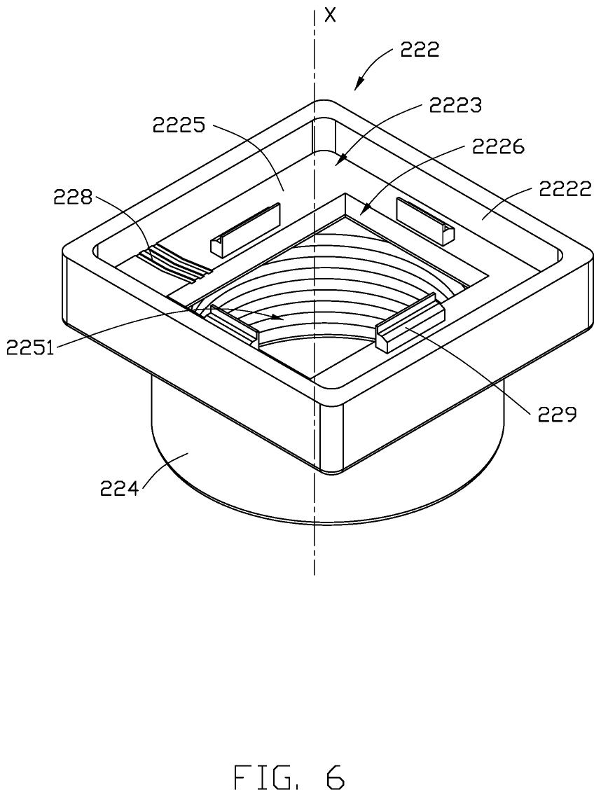

Referring to FIG. 6, the optical filter 223 is disposed on the second surface 2225 and covers the opening 2226. At this time, the protrusion 229 is located at a periphery of the optical filter 223.

At block 303, the protrusion 229 is hot melted and bent.

Referring to FIGS. 5 and 6, in at least one embodiment, one end of the protrusion 229 away from the second surface 2225 is bent toward a central axis X direction of the lens holder 221 by the indenter (not shown) onto the optical filter 223.

At block 304, the protrusion 229 is cooled to fix the optical filter 223 on the second surface 2225. The protrusion 229 after being hot melted, bent and cooled is the fixing block 226. In at least one embodiment, the protrusion 229 is a rivet. Fixing the optical filter 223 by rivet increases the impact resistance and reliability of the camera module 20, and increases adaptability for extreme environments such as those including long-term vibration and alternating temperature.

At block 305, a substrate 21 is provided.

Referring to FIGS. 3 and 4, the substrate 21 includes an upper surface 211 and a lower surface 212 opposite the upper surface 211. In at least one embodiment, the substrate 21 is a RF (radio frequency) printed circuit board.

In at least one embodiment, an electric connecting member 213 is disposed on the upper surface 211. The electric connecting member 213 can be a connector, a connecting finger, or other element that acts as an electrical connection.

Further, a photosensitive chip 214 and a plurality of electronic components 215 are disposed on the upper surface 211. In at least one embodiment, the photosensitive chip 214 and the plurality of the electronic components 215 are disposed on a side of the upper surface 211 away from the electric connecting member 213. The electronic component 215 can be selected from one or more of a resistor, a capacitor, a diode, a transistor, a relay, a memory, and other passive components.

In at least one embodiment, the plurality of the electronic components 215 are disposed around a periphery of the photosensitive chip 214. In other embodiments, the plurality of the electronic components 215 are arranged in two columns, and the photosensitive chip 214 is located between two columns of electronic components 215.

At block 306, the lens holder 221 is disposed on the upper surface 211 of the substrate 21. The photosensitive chip 214 and the electronic component 215 are received in the accommodating space 2223 of the first holder portion 222.

In at least one embodiment, an adhesive layer 23 is disposed between the substrate 21 and the lens assembly 22. The substrate 21 and the lens assembly 22 are connected by the adhesive layer 23.

In other embodiments, the adhesive layer 23 can be omitted. As such, the substrate 21 and the lens assembly 22 may be connected by snap-fitting, soldering, or screwing.

At block 307, a lens 225 is provided and the lens 225 is disposed on the second holder portion 224.

In at least one embodiment, an outer surface of the lens 225 is provided with an external thread corresponding to the internal thread of the circumferential surface 2252. As such, the lens 225 and the second holder portion 224 are connected by the cooperation of the internal thread and the external thread. The lens 225 is received in the through hole 2251 and exposed to the through hole 2251.

In the present disclosure, fixing the optical filter 223 by the fixing block 226 saves glue, and sealing of the escape groove 228 is not required. In the prior art, since the drying of glue requires an oven, the manufacturing cost of the camera module 20 is higher. Drying the glue in the oven also increases the production time of the camera module 20. Further, the glue increases the total size of optical filter 223.

Moreover, fixing the optical filter 223 on the first holder portion 222 by the fixing block 226 increases the impact resistance and reliability of the camera module 20, and increases adaptability for extreme environments such as long-term vibration and alternating temperature is improved. In addition, the fixing block 226 causes the camera module 20 to have more stable structure and a lower cost.

It is to be understood, however, that even through numerous characteristics and advantages of the present disclosure have been set forth in the foregoing description, together with details of assembly and function, the disclosure is illustrative only, and changes may be made in details, especially in the matters of shape, size, and arrangement of parts within the principles of the disclosure to the full extent indicated by the broad general meaning of the terms in which the appended claims are expressed.

What is claimed is:

1. A camera module, comprising:
a substrate; and
a lens assembly disposed on the substrate, the lens assembly comprising:
a lens holder comprising:
a first holder portion comprising a peripheral wall and a flange protruding from an inner wall of the peripheral wall;
a second holder portion disposed on the first holder portion, and
a fixing block, wherein the fixing block is disposed on a surface of the flange away from the second holder portion, the fixing block and the flange cooperatively form a clamping slot;
an optical filter, wherein the optical filter is disposed on the surface of the flange away from the second holder portion, and an edge portion of the optical filter is received in the clamping slot; and
a lens disposed in the second holder portion.

2. The camera module of claim 1, wherein the fixing block comprises a first fixing portion and a second fixing portion, an end of the first fixing portion is connected to the surface of the flange away from the second holder portion; an end of the second fixing portion is connected to an end of the first fixing portion away from the first holder portion, the second fixing portion extends toward a central axis of the lens holder; the second fixing portion, the first fixing portion, and the flange cooperatively form the clamping slot.

3. The camera module of claim 1, wherein the camera module comprises an adhesive layer connected between the first holder portion and the substrate.

4. The camera module of claim 3, wherein the first holder portion further comprises a top wall, the peripheral wall is disposed on a periphery of the top wall, the flange defines an opening, the optical filter covers the opening, the fixing block is located on a portion of the flange surrounding the optical filter.

5. The camera module of claim 4, wherein the second holder portion defines a through hole, the through hole is connected to the opening, the lens is received in the through hole and exposed to the second holder portion.

6. The camera module of claim 4, wherein the surface of the flange away from the second holder portion defines an escape groove, the escape groove is connected to the opening.

7. An electronic device comprising:
a body, and
a camera module being receiving in the body, the camera module comprising:
a substrate; and
a lens assembly disposed on the substrate, the lens assembly comprising:
a lens holder comprising:
a first holder portion comprising a peripheral wall and a flange protruding from an inner wall of the peripheral wall;
a second holder portion disposed on the first holder portion, and
a fixing block, wherein the fixing block is disposed on a surface of the flange away from the second holder portion, the fixing block and the flange cooperatively form a clamping slot;
an optical filter, wherein the optical filter is disposed on the surface of the flange away from the second holder portion, and an edge portion of the optical filter is received in the clamping slot; and
a lens disposed in the second holder portion.

8. The electronic device of claim 7, wherein the fixing block comprises a first fixing portion and a second fixing portion, an end of the first fixing portion is connected to the surface of the flange away from the second holder portion; an end of the second fixing portion is connected to an end of the first fixing portion away from the first holder portion, the second fixing portion extends toward a central axis of the lens holder; the second fixing portion, the first fixing portion and the flange cooperatively form the clamping slot.

9. The electronic device of claim 7, wherein the camera module comprises an adhesive layer between the first holder portion and the substrate.

10. The electronic device of claim 7, wherein the first holder portion further comprises a top wall, the peripheral wall is disposed on a periphery of the top wall, the flange defines an opening, the optical filter covers the opening, the fixing block is located on a portion of the flange surrounding the optical filter.

11. The electronic device of claim 10, wherein the second holder portion defines a through hole, the through hole is connected to the opening, the lens is received in the through hole and exposed to the second holder portion.

12. The electronic device of claim 10, wherein the surface of the flange away from the second holder portion defines an escape groove, the escape groove is connected to the opening.

13. A method for manufacturing a camera module, comprising
providing a lens holder, wherein the lens holder comprises a first holder portion, a second holder portion and a protrusion, the first holder portion comprising a peripheral wall and a flange protruding from an inner wall of the peripheral wall, the second holder portion is disposed on the first holder portion, the protrusion is disposed on a surface of the flange away from the second holder portion;
providing an optical filter;
placing the optical filter on the surface of the flange away from the second holder portion;
hot-melting the protrusion and bending an end of the protrusion away from the first holder portion onto the optical filter;
disposing a substrate on the lens holder; and
disposing a lens in the second holder portion.

14. The method of claim 13, wherein the first holder portion is integrally formed with the second holder portion and the protrusion.

15. The method of claim 13, wherein the protrusion is a rivet.
